(19) United States
(12) Patent Application Publication
(10) Pub. No.: US 2014/0104184 A1
(43) Pub. Date: Apr. 17, 2014

(54) BACKPLATE ELECTRODE SENSOR

(71) Applicant: QUALCOMM MEMS TECHNOLOGIES, INC., San Diego, CA (US)

(72) Inventors: James C. Meador, Berkeley, CA (US); Igor Tchertkov, Pleasanton, CA (US)

(73) Assignee: QUALCOMM MEMS Technologies, Inc., San Diego, CA (US)

(21) Appl. No.: 13/649,423

(22) Filed: Oct. 11, 2012

(51) Int. Cl. G06F 3/041; H01R 43/00

(52) U.S. Cl. 345/173; 29/825

(57) ABSTRACT

This disclosure provides systems, methods and apparatus for electromechanical systems (EMS) device packages having integrated sensors. In one aspect, electrodes within a packaged EMS device can be used in conjunction with an electrode disposed on another substrate within the EMS device package to form one or more capacitive sensors. The capacitive sensor may be used to determine the relative deformation of substrates within the EMS device package, which can in turn be used as part of a pressure, touch, mass, or impact measuring system.

### TECHNICAL FIELD

This disclosure relates to electromechanical systems (EMS) device packages and sensors which can be integrated into EMS device packages.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Many EMS device packages, including display devices, cellular phones, and tablet computers include discrete sensing components in order to provide additional functionality to the device. However, incorporation of such additional sensing components, such as accelerometers or pressure sensors, adds to the cost and complexity of the device, and represents a tradeoff between added functionality and added cost.

### SUMMARY

The systems, methods and devices of this disclosure each have several innovative aspects, no single one of which is solely responsible for the desirable attributes disclosed herein.

One innovative aspect of the subject matter described in this disclosure can be implemented in an electromechanical systems (EMS) device package, including a substrate having a first surface, at least one EMS device supported by the first surface of the substrate, the at least one EMS device including an electrode configured to be placed in electrical communication with sensing circuitry, a backplate sealed to the first substrate to form a cavity enclosing the at least one EMS device, and at least one sensor electrode supported by the backplate and configured to be placed in electrical communication with the sensing circuitry to form a capacitive sensor between the sensor electrode and the electrode of the at least one EMS device.

In some implementations, the package can include a plurality of sensor electrodes supported by the backplate, and a plurality of EMS devices supported by the first surface of the backplate, where the plurality of sensor electrodes are configured to be placed in communication with electrodes in the plurality of EMS devices to form a plurality of capacitive sensors. In one further implementation, the plurality of sensor electrodes can include an array of sensor electrodes arranged in a grid. In another further implementation, the plurality of sensor electrodes can include the at least one sensor electrode and a second electrode disposed along a periphery of the at least one sensor electrode. In a still further implementation, the second electrode can be a substantially annular electrode circumscribing the at least one sensor electrode.

In some implementations, the sensing circuitry can be configured to measure a signal indicative of the capacitance between the at least one sensor electrode and the electrode of the at least one EMS device. In one further implementation, the sensing circuitry can be additionally configured to estimate the weight of an object supported by the EMS device package based at least in part on a measure of the capacitance between the at least one sensor electrode and the electrode of the at least one EMS device. In another further implementation, the sensing circuitry can be additionally configured to determine a pressure difference between a pressure within the package and an ambient pressure outside the package. In one still further implementation, the package can additionally include a temperature sensor. In another still further implementation, the sensing circuitry can be additionally configured to estimate an altitude of the package. In another further implementation, the at least one sensor electrode can include a plurality of sensor electrodes, and the sensing circuitry can be additionally configured to estimate a location of a touch event relative to the package. In another further implementation, the package can additionally include at least one band-pass filter in electrical communication with the sensing circuitry. In a still further implementation, the at least one band-pass filter can tuned to a frequency indicative of an impact on the package, and the sensing circuitry can be additionally configured to determine whether the package has sustained an impact based at least in part on a measure of the capacitance between the at least one sensor electrode and the electrode of the at least one as a function of time.

In some implementations, the at least one sensor electrode can be disposed on a surface of the backplate facing the substrate. In some implementations, the at least one sensor electrode can be disposed on a surface of the backplate opposite the substrate.

In some implementations, the EMS device can form a portion of a display, the package further including a processor that is configured to communicate with the display, the processor being configured to process image data, and a memory device that is configured to communicate with the processor. In one further implementation, the package can further include a driver circuit configured to send at least one signal to the display, and a controller configured to send at least a portion of the image data to the driver circuit. In a still further implementation, the driver circuit can include the sensing circuitry. In another further implementation, the package can further include an image source module configured to send the image data to the processor, where the image source module includes at least one of a receiver, transceiver, and transmitter. In another further implementation, the package can further include an input device configured to receive input data and to communicate the input data to the processor.

Another innovative aspect of the subject matter described in this disclosure can be implemented in a method, the method including placing a sensor electrode in electrical communication with sensing circuitry, where the sensor electrode is supported by a backplate, placing an electrode in an electromechanical systems (EMS) device in electrical communication with the sensing circuitry, where the EMS device is supported by a first surface of a substrate, and where the backplate is separated from the substrate by a cavity and sealed to the first surface of the substrate to form a package containing the EMS device, and measuring a signal indicative of a capacitance between the sensor electrode and the electrode in the EMS device.

In some implementations, the method can further include determining a measure of the relative displacement between the substrate and the backplate based at least in part on the signal indicative of the capacitance between the sensor electrode and the electrode in the EMS device. In some implementations, the method can further include determining, based on the signal indicative of the capacitance between the sensor electrode and the electrode in the EMS device, an indication of a pressure difference between a pressure within the package and an ambient pressure outside the package. In a further implementation, the method can further include estimating, based on the indication of the pressure difference, an altitude of the package. In a still further implementation, the method can further include determining an indication of the temperature of the package, where determining an altitude of the package is also based on the indication of the temperature of the package.

In some implementations, the method can further include estimating a mass of an object supported by the package based on the signal indicative of the capacitance between the sensor electrode and the electrode in the EMS device. In some implementations, placing the sensor electrode in electrical communication with the electrode in the EMS device can include placing each of a plurality of sensor electrodes in electrical communication with the sensing circuitry to form a plurality of capacitive sensors, and the method can further include, for each capacitive sensor, measuring a signal indicative of the capacitance of the capacitive sensor, and estimating a location of a touch event relative to the package based at least in part on the measured signals indicative of the capacitance of the capacitive sensors. In one further implementation, at least some of plurality of capacitive sensors can be formed sequentially. In another further implementation, at least some of plurality of capacitive sensors can be formed simultaneously.

In some implementations, measuring a signal indicative of the capacitance between the sensor electrode and the electrode in the EMS device can include measuring a signal indicative of the capacitance over a period of time, and the method can additionally include filtering the measured signal using at least one band-pass filter. In a further implementation, the method can further include identifying an occurrence of an impact sustained by the package based at least on part on a filtered signal formed by filtering the measured signal using the at least one band-pass filter.

Another innovative aspect of the subject matter described in this disclosure can be implemented in an electromechanical systems (EMS) device package, including a substrate having a first surface, at least one EMS device supported by the first surface of the substrate, the at least one EMS device including an electrode, a backplate sealed to the first substrate to form a cavity enclosing the at least one EMS device, and means for sensing a relative displacement between the substrate and the backplate, where the sensing means are supported by the backplate.

In some implementations, the sensing means can include at least one sensor electrode supported by the backplate and configured to be placed in electrical communication with sensing circuitry to form a capacitive sensor between the sensor electrode and the electrode of the at least one EMS device.

Another innovative aspect of the subject matter described in this disclosure can be implemented in a method of fabricating an electromechanical systems device (EMS) package, the method including providing a substrate supporting an EMS device, where the EMS device includes at least one electrode, providing a backplate supporting at least one sensor electrode, joining the substrate to the backplate to form an EMS device package including the EMS device, and forming conductive structures allowing electrical communication between sensing circuitry and the at least one sensor electrode, and between the sensing circuitry and the at least one electrode of the EMS device.

In some implementations, the backplate can additionally support sensing circuitry connected to the at least one sensor electrode. In some implementations, the substrate can additionally support sensing circuitry connected to the at least one electrode of the EMS device. In some implementations, the at least one sensor electrode can include an array of sensor electrodes. In some implementations, the at least one sensor electrode can include a central sensor electrode and at least one annular sensor electrode extending around the periphery of the central sensor electrode. In some implementations, the sensing circuitry can form at least a portion of a driver circuit configured to control the EMS device.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIGS. 3A and 3B are schematic exploded partial perspective views of a portion of an EMS package including an array of EMS elements and a backplate.

FIG. 4A shows an example of an exploded view of an EMS device package with a sensor electrode supported on an interior surface of a backplate.

FIG. 4B shows a cross-sectional view of the assembled EMS device package of FIG. 1A.

FIG. 5 shows an example of a flow diagram illustrating a sensing method using an EMS device package having an integrated sensor electrode.

FIG. 6 shows an exploded view of another implementation of an EMS device package with a sensor electrode supported on an exterior surface of a backplate.

FIG. 7 shows an example of a flow diagram illustrating a sensing method using an EMS device package having an integrated sensor electrode.

FIG. 8 shows an example of an EMS device package supporting an object to be weighed.

FIG. 9 shows an example of a flow diagram illustrating a method of measuring a mass of an object placed on an EMS device package having an integrated sensor electrode.

FIG. 10 shows an exploded view of another implementation of an EMS device package with more than one sensor electrode supported on an interior surface of a backplate.

FIG. 11 shows an example of a flow diagram illustrating a method of sensing a touch event using an array of backplate sensors.

FIG. 12 shows a plot of induced changes in capacitance over time in response to both a stimulus that causes a low frequency oscillation and a stimulus that causes a high frequency oscillation.

FIG. 13 shows an example of a flow diagram illustrating a method of detecting an impact on an EMS device package.

FIG. 14 shows an example of a flow diagram illustrating a method of fabricating an EMS device package having an integrated backplate sensor.

FIGS. 15A and 15B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

An electromechanical systems (EMS) device package may include a substrate supporting one or more EMS devices, and a backplate spaced apart from the devices. The backplate can deform relative to the supporting substrate in response to a variety of environmental or mechanical stimulus. By including at least one sensor electrode supported by the backplate, a change in capacitance between the sensor electrode and an electrode within the EMS device can be used to provide an indication of a wide variety of environmental or physical conditions, based on the relative deformation between the backplate and the substrate. For example, the ambient pressure and altitude can be determined based on a measurement of the capacitance between the sensor electrode and an electrode of the EMS device. The EMS device package can also be used as a scale to measure the mass of an object placed on the EMS device package. The relative oscillation of the EMS substrate and the backplate relative to one another can also be analyzed as part of an impact sensor. If more than one sensor electrode is provided on the backplate, the sensor electrodes can be used as part of a touch sensing system.

Particular implementations of the subject matter described in this disclosure can be implemented to realize one or more of the following potential advantages. Because an EMS device package may already include a backplate, integration of a sensor electrode requires minimal changes to the structure of the EMS device packages. Because the additional structure to be added is minimal, there is very little additional cost, and little or no impact on the physical size of the device. In addition, for EMS devices which include capacitive structures, capacitive sensing using the sensor electrode can be performed by existing driver circuitry with minimal, if any, alterations to the driving circuitry. [0031] An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

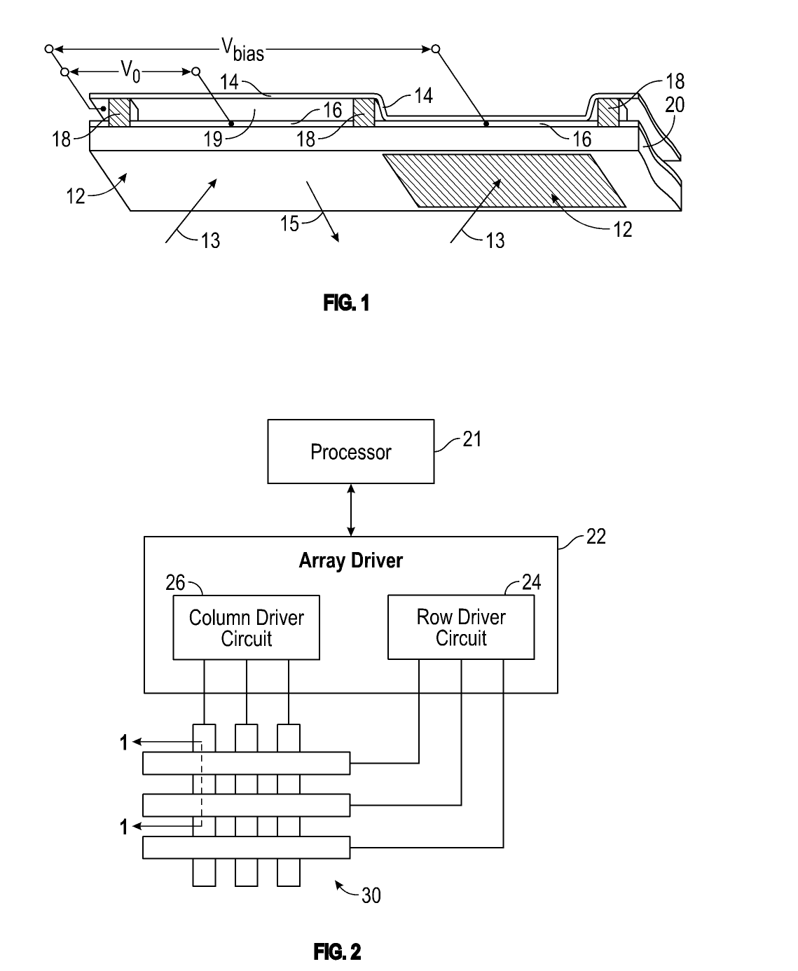

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

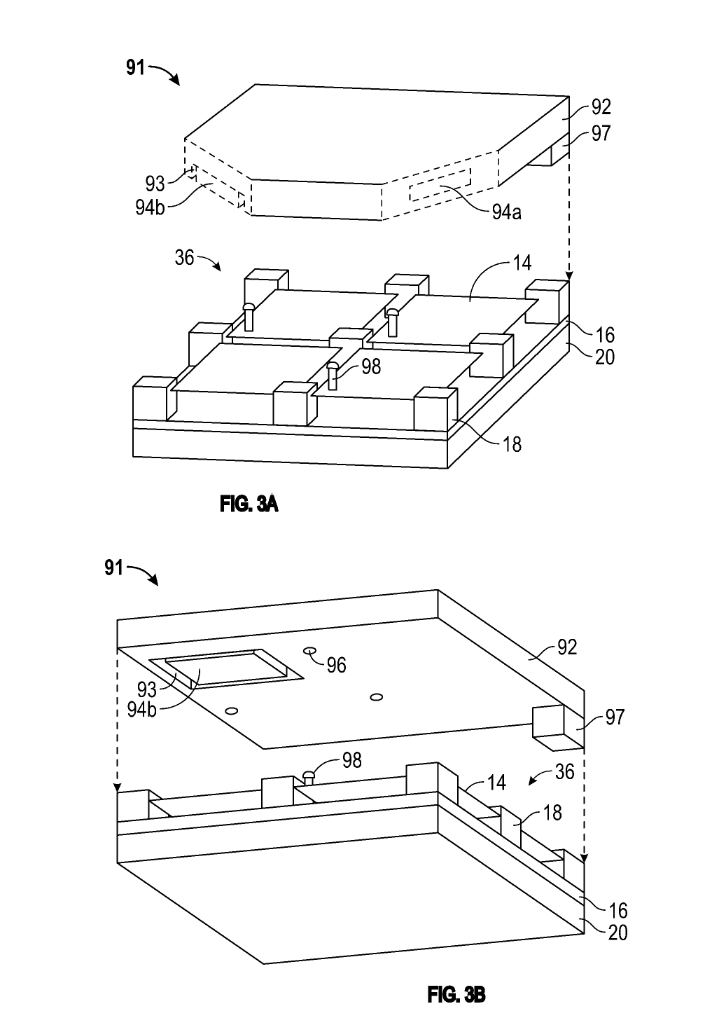

FIGS. 3A and 3B are schematic exploded partial perspective views of a portion of an EMS package 91 including an array 36 of EMS elements and a backplate 92. FIG. 3A is shown with two corners of the backplate 92 cut away to better illustrate certain portions of the backplate 92, while FIG. 3B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 3A and 3B, the backplate 92 can include one or more backplate components 94a and 94b, which can be partially or wholly embedded in the backplate 92. As can be seen in FIG. 3A, backplate component 94a is embedded in the backplate 92. As can be seen in FIGS. 3A and 3B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 3B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb at least part of the moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 3A and 3B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 3A and 3B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

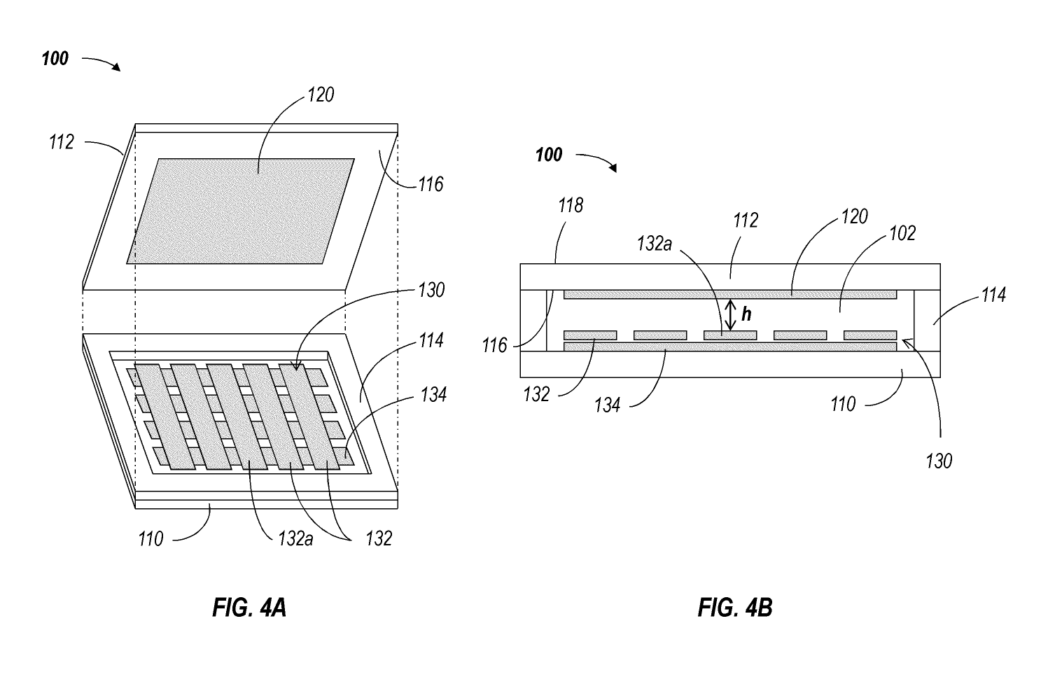

FIG. 4A shows an example of an exploded view of an EMS device package with a sensor electrode supported on an interior surface of a backplate. The EMS device package 100 includes an EMS substrate 110 supporting an array 130 of EMS devices. In some implementations, the EMS devices within the array 130 may include IMODs such as those discussed above, while in other implementations a wide variety of other EMS devices may also be used, such as MEMS switches, varactors, micromirror devices, or any other suitable EMS devices. For convenience, the EMS devices within the array 130 or similar structures may be referred to herein as IMODs, although it will be understood that other EMS devices can also be used in the implementations discussed below.

In addition, the array 130 need not include only EMS devices. In some implementations, the array 130 may include non-EMS devices, such as non-EMS display elements, along with at least one EMS device. For example, in some implementations, the array 130 may include one or more MEMS switches disposed throughout or adjacent an array of LED elements. In other implementations, an array 130 of otherwise non-EMS elements may include a dedicated EMS device configured to interact with a sensor electrode and the EMS device need not serve any secondary purpose.

In the illustrated implementation, the array 130 includes a plurality of column electrodes 134 and a plurality of row electrodes 132 overlying and extending generally perpendicular to the plurality of column electrodes 134. Although described herein as row and column electrodes for convenience, the particular orientation of the array is not important, and the row and column electrodes may alternately be referred to as common and segment electrodes, for example. In the particular implementation illustrated herein, the plurality of column electrodes 134 and the plurality of row electrodes 132 form an array of IMODs 136 at each intersection at which a column electrode 134 overlies a row electrode 132

The EMS device package also includes a backplate 112 which will be secured to the EMS substrate 110 via a seal 114 extending around the perimeter of the array 130. This seal 114 may be a hermetic or semi-hermetic seal, and may extend fully around the array 130 as depicted, or may include one or more breaks in the seal 114 to allow access to the interview of the EMS device package 110 after the backplate 112 is secured to the EMS substrate 110. In some implementations, the seal 114 is not formed on the EMS substrate 110, but can be formed on the backplate 112 or can be a separate structure inserted between the backplate 112 and the EMS substrate 110.

Formed on the interior surface 116 of the backplate 112 is a sensor electrode 120. In the implementation of FIG. 4A the sensor electrode 120 is a single electrode, although other alternatives will be discussed in greater detail below with respect to other implementations. In other implementations depicted below, the sensor electrode may be formed on the exterior surface 118 (see FIG. 1B) of the backplate 112, or may be disposed within the backplate 112.

FIG. 4B shows a cross-sectional view of the assembled EMS device package of FIG. 4A. Once the EMS substrate 110 and the backplate 112 are sealed together to form an assembled EMS device package 100, a cavity 102 is formed with a height h between the sensor electrode 120 and an upper row electrode 132 of the EMS array 130. Conductive structures such as electrical traces (not shown) can be used to place the sensor electrode 120 in electrical communication with control and/or sensing circuitry (not shown). The upper row electrode 132 of the EMS array 130 can similarly be placed in communication with control and/or sensing circuitry (not shown). As described above, the control and/or sensing circuitry in electrical communication with the sensor electrode 120, and in electrical communication with the upper row electrode 132 of the EMS array 130 may in some implementations be part of the driver circuitry configured to control the EMS array 130, or may be part of some other discrete circuitry.

When the sensor electrode 120 is placed in electrical communication with one or more row electrodes 132, a capacitor is formed between the sensor electrode 120 and the upper row electrode 132 of the EMS array 130. The capacitance of this capacitor, or a signal indicative of the capacitance of the capacitor, can be measured through any suitable method, and provides an indication of the height h of the cavity 102 and the amount of relative deformation between the EMS substrate 110 and the backplate 112.

In some implementations, the sensor electrode 120 can be placed in electrical communication with a single row electrode 132. In particular implementations, the sensor electrode can be placed in electrical communication with a row electrode 132a located near the center of the device, where the deformation of the backplate and the resultant change in the height h of the capacitor will be at their greatest. In other implementations, a plurality or all of row electrodes 132 may be gang-driven together. As used herein, the term capacitor can refer both to capacitive sensing structures in which a single sensor electrode 120 and a single row electrode 132 are placed in electrical communication with control and/or sensing circuitry, and to capacitive sensing structures in which more than one sensor electrode 120 or row electrode 132 are gang-driven together to form a portion of the capacitive sensing structure.

In an implementation in which the EMS device array 130 is a display array, and a given row electrode 132 is associated with a particular color, the various row electrodes 132 associated with a particular color may be scanned together. Such a color-based scanning process may be readily performed by existing display device drivers. In other implementations, the row electrodes 132 can be sequentially scanned to provide an indication of the shape of the deformation of the backplate 112 relative to the EMS substrate 110. For example, the row electrodes 132 near the periphery of the array 130 will experience less relative deformation between the row electrodes 132 and the sensor electrode 120 than will be experienced by the central row electrode(s) 132a.

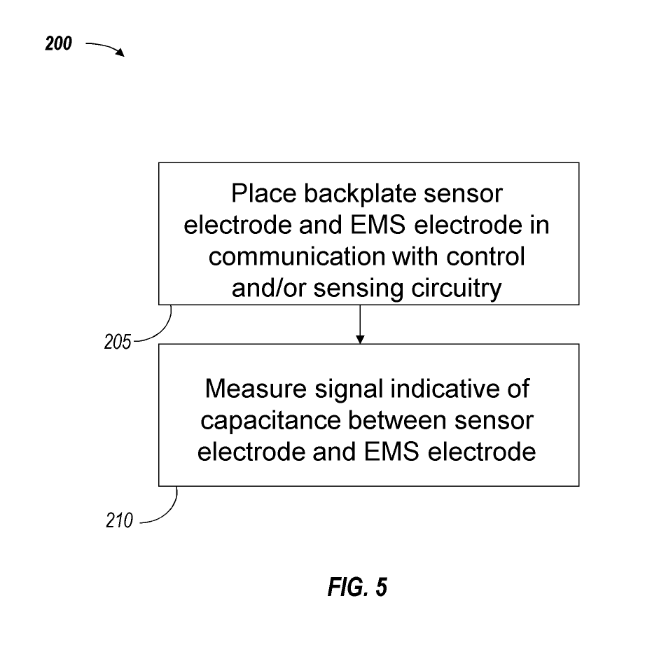

FIG. 5 shows an example of a flow diagram illustrating a sensing method using an EMS device package having an integrated sensor electrode. The method 200 begins at a block 205 where a sensor electrode supported by a backplate of an EMS device package is placed in electrical communication with control and/or sensing circuitry, and an electrode in an EMS device supported by a substrate sealed to the backplate is also placed in electrical communication with control and/or sensing circuitry. The backplate can be spaced apart from the EMS substrate by a cavity, such that the sensor electrode is spaced apart from the electrode in the EMS device package by a distance which is dependent on the relative deformation of the backplate relative to the EMS substrate, and a capacitor is formed between the sensor electrode and the EMS electrode. In some implementations, the EMS device includes an IMOD, and the electrode in the EMS device is the movable layer in the IMOD. In other implementations, the EMS device may be another suitable EMS device other than an IMOD.

The method 200 then moves to a block 210 where a signal or value indicative of the capacitance between the sensor electrode and the EMS electrode is measured. In some implementations, the signal may be a signal indicative of a current through the circuit including the capacitor, although other signals indicative of the capacitance may be measured. In some implementations, the method may also include a calculation of the capacitance, although in other implementations the measured signal may be correlated with a measured parameter of the EMS device without directly calculating the capacitance of the capacitor formed by the sensor electrode and the EMS electrode.

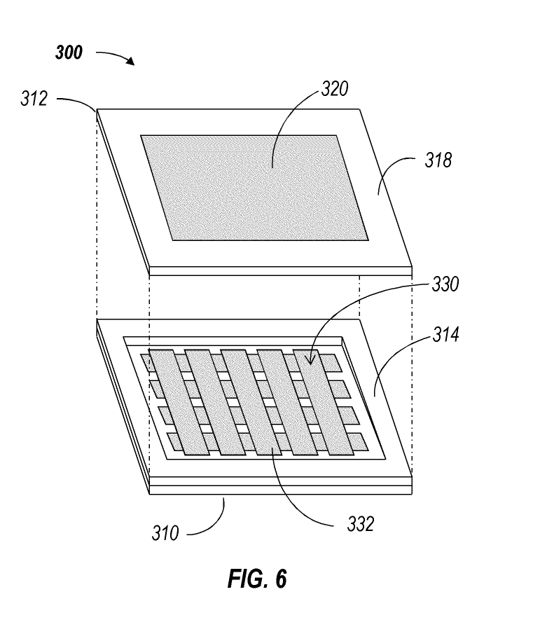

In further implementations, the sensor electrode may be located outside of the EMS device package. FIG. 6 shows an exploded view of another implementation of an EMS device package with a sensor electrode supported on an exterior surface of a backplate. The EMS device package 300 of FIG. 6 is similar to the EMS device package 100 of FIGS. 4A-4B, including an array 330 of EMS devices disposed on a surface of an EMS substrate 310 and circumscribed by a seal 314.

However, the EMS device package 300 differs from the EMS device package 100 of FIG. 4A-4B in that the EMS device package 300 includes a sensor electrode 320 formed on the exterior surface 318 of the backplate 312. The spacing between the sensor electrode 320 and the upper row electrode 332 of EMS array 330 will be increased by the thickness of the backplate 312 compared to the EMS device package 100 of FIGS. 4A-4B. By disposing the sensor electrode 320 on the exterior surface 318 of the backplate 312, inadvertent shorting between the sensor electrode 320 and conductive portions of the EMS array 330 can be prevented.

In some implementations, an EMS device package may include a backplate which includes a contoured, curved, or otherwise non-flat portion. In such implementations, a sensor electrode may be sized and/or dimensioned to be positioned on a flat portion of the backplate, rather than the curved surface. The size and shape of a sensor electrode may also vary significantly in certain implementations. In some particular implementations, the sensor electrode may extend over a significant portion of the backplate surface, while in other implementations the sensor electrode may cover a smaller area of the backplate surface. In some implementations, the sensor electrode may be disposed near the center of the backplate as discussed above, where the relative displacement of the backplate and the EMS substrate will be greatest, in order to increase the sensitivity of the sensing system.

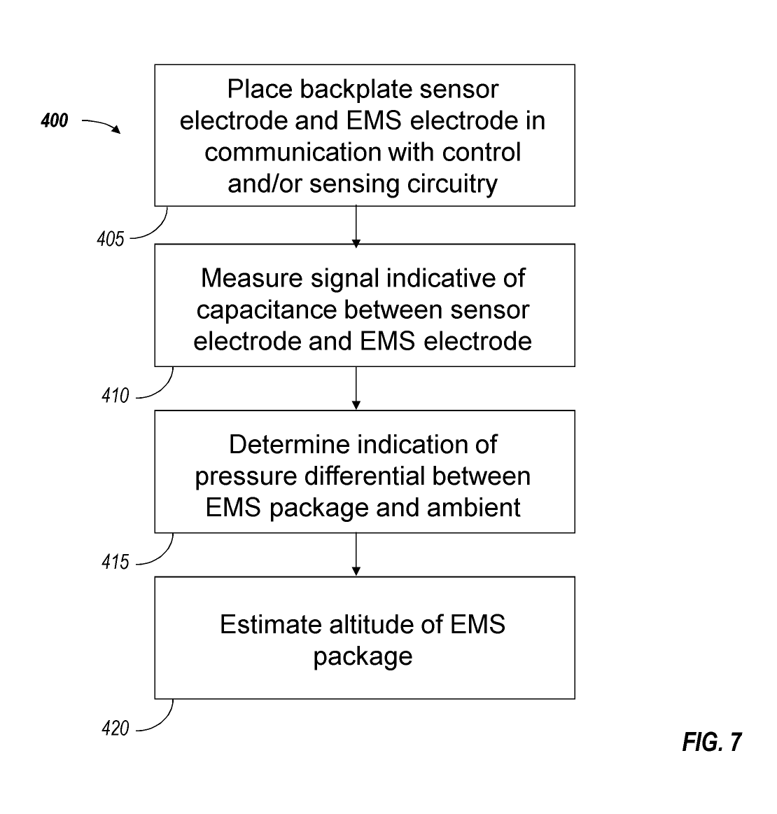

In one implementation, a sensor electrode disposed on a backplate of an EMS device package may be used to provide an indication of the ambient pressure. FIG. 7 shows an example of a flow diagram illustrating a sensing method using an EMS device package having an integrated sensor electrode. The method 400 is initially similar to the method 200 of FIG. 5, and begins at a block 405 where a sensor electrode disposed on a backplate of an EMS device package is placed in electrical communication with control and/or sensing circuitry, and an electrode in an EMS device supported by a substrate sealed to the backplate is also placed in electrical communication with control and/or sensing circuitry. The method 400 then moves to a block 410 where a signal indicative of the capacitance between the sensor electrode and the EMS electrode is measured. In some implementations, the method additionally includes determining the capacitance based on the measured signal, although in other implementations such a step may not be performed, as discussed in greater detail below.

The method 400 then moves to a block 415, where an indication of the pressure differential between the EMS device package and the ambient is determined. When the cavity of an EMS device package is hermetically sealed, a change in ambient pressure will result in a change in the height h (see FIG. 3A) between the EMS electrode in the array and the sensor electrode disposed on the backplate, due to the pressure gradient between the EMS device package pressure and the ambient pressure. By measuring the capacitance, or a signal indicative of the capacitance, and subsequently correlating the capacitance (or signal indicative of the same) with measurements at known ambient pressures, the current ambient pressure can be determined. In some implementations, the method may additionally include the measurement of the current temperature, in order to compensate for the effect of temperature changes on the pressure gradient between the EMS device package and the ambient. [0076] In some implementations, the method 400 may proceed to a block 420 where the altitude of the EMS device package is determined. In some implementations, the determination may be based on the ambient pressure determined at block 415, and in further implementations, the current temperature may be used to compensate for the effect of temperature on the ambient and package pressures. In some implementations, the ambient pressure need not be explicitly determined in order to determine the altitude. Rather, the signal or value indicative of the capacitance between the sensor electrode and the EMS electrode can be directly correlated with the current altitude, such as through the use of a lookup table, and a signal or value indicative of the current temperature may be used in addition, to compensate for temperature effects. Thus, the inclusion of a sensor electrode on a backplate can provide an integrated altimeter at minimal cost, leveraging the structure of EMS device packages configured to protect EMS devices such as interferometric modulators.

In some implementations, rather than relying on only a single measurement of a signal indicative of the capacitance between the sensor electrode and the EMS electrode, a series of measurements may be performed over a period of time. If the period of time is sufficiently short to allow the pressure gradient between the EMS package and the ambient to be presumed constant, an average of the measurements may be used instead of a single measurement. By averaging multiple measurements, variations in package deformation resulting from, for example, a user moving or holding the EMS device package can be compensated for, improving the accuracy of the pressure or altitude measurement. In one particular implementation, measurement sensitivity sufficient to detect changes on the order of about 9.8 fF, in a system in which the noise is less than about 3.3fF, will be sufficiently precise to detect changes in altitude within about 0.5 meters.

Although the method 400 is described with respect to a particular implementation in which the EMS device package is hermetically sealed, the method 400 or a similar method may also be performed when an EMS device package is not hermetically sealed, but is sufficiently sealed that there is a lag before pressure equalization between the interior of the EMD device package and the ambient. In some implementations, the seal may be a semi-hermetic seal, where some pressure differential can be maintained for hours, days, months, or even years. In other implementations, the pressure differential may fade after a shorter period of time due to the use of a less hermetic seal. An induced pressure differential, such as a pressure differential resulting from movement on an elevator, can still be used to provide an indication of for example an altitude change based on the relative pressure differential. For example, in one particular implementation, a change in pressure differential can be used to determine the particular floor of a building an elevator has brought the EMS device package to, based on an estimate of the altitude change. In turn, information such as a map regarding the current floor can be provided via the EMS device or through other means. In further implementations, such an estimate can take into account an expected leakage rate between the device package and the ambient in order to improve the accuracy of the estimate.

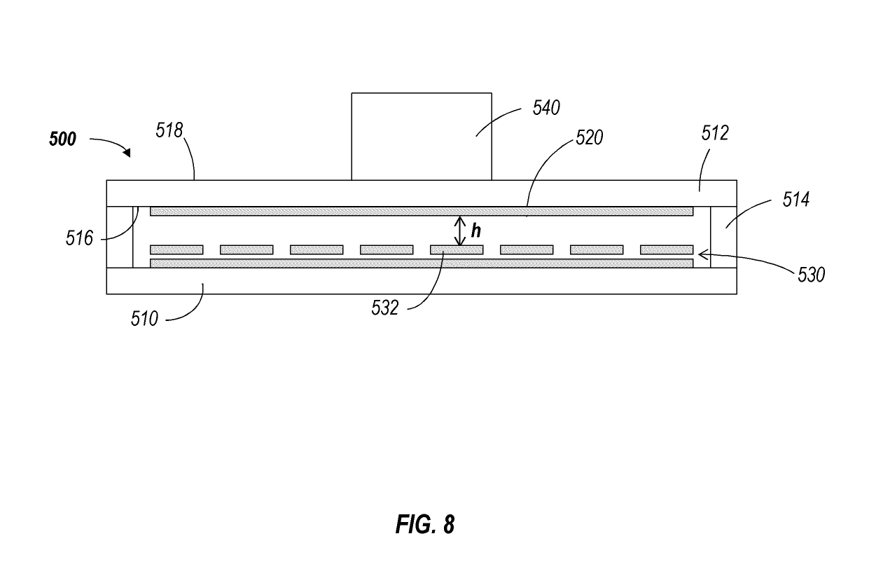

In other implementations, a sensor electrode integrated into an EMS device package can be used to provide an indication of a load on one of the surfaces of the EMS device package. For example, the sensor electrode can be used to measure the weight of an object placed on the EMS device package. FIG. 8 shows an example of an EMS device package supporting an object to be weighed. The EMS device package 500 includes a backplate 512 secured to an EMS substrate 510 via a seal 514 extending around the perimeter of an array 530 of EMS devices. A sensor electrode 520 is disposed on an interior surface 516 of the backplate 512 and placed in electrical communication with one or more electrodes 532 in the EMS array 530. An object 540 is placed on an exterior surface 518 of the backplate 512 or the EMS substrate 510 (as in the illustrated implementation), resulting in a deformation of one of the backplate 512 or the EMS substrate 510 towards the other. The change in the capacitance between the sensor electrode 520 and the EMS electrode 532 due to a reduction in the height h between the two can be measured, and the mass of the object 540 can be determined.

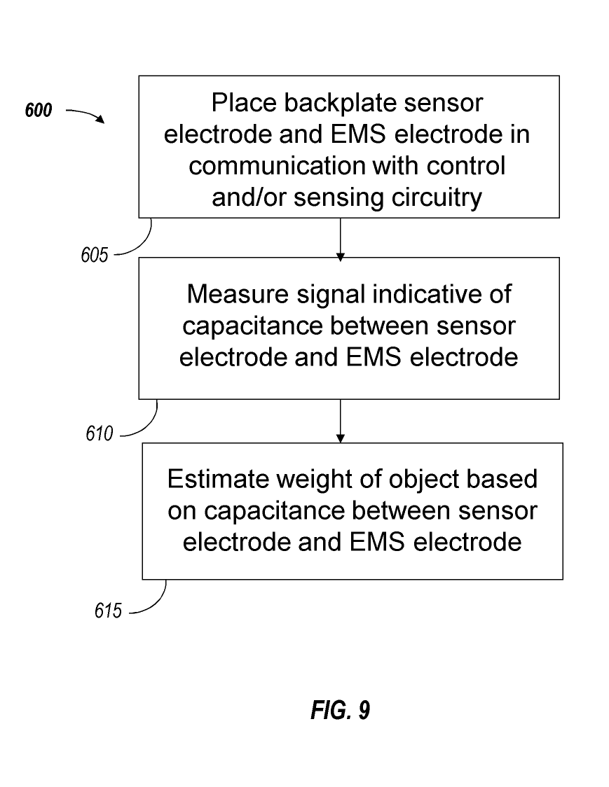

FIG. 9 shows an example of a flow diagram illustrating a method of measuring the weight of an object placed on an EMS device package having an integrated sensor electrode. The positioning of the object relative to the supporting structure of the seal will affect the overall deformation of the backplate. Due to this effect, the object is preferably be placed where the weight of the object will result in the maximum deformation of the load-bearing substrate, typically in the center of the load-bearing substrate unless, for example, the seal is formed in an irregular shape.

In some implementations, placement of the object on the EMS substrate can facilitate this positioning, particularly when the EMS array is a display array viewable through the EMS substrate. For example, an EMS display can be used to display a point on which the object should be centered to maximize the deformation of the load-bearing substrate

In further implementations, placement of the object at the position of maximum displacement can be verified, and feedback provided to a user if necessary to direct adjustment of the object placement. If the EMS electrode is one of many EMS electrodes in the array, the capacitance between each of multiple EMS electrodes and the sensor electrode can be sequentially determined. If the load-bearing substrate is not symmetrically deformed relative to a centermost EMS electrode, feedback to a user can be provided to direct repositioning of the object, or the off-center positioning can be taken into account when determining the mass of the object resulting in the deformation.

Once the object is positioned on the EMS device package, the illustrated method 600 begins at a block 605 where an electrode in the EMS array and a sensor electrode supported by the backplate are placed in electrical communication with control and/or sensing circuitry, in a similar fashion to the implementations discussed above. The method 600 then moves to a block 610 where a signal or value indicative of the capacitance between the EMS electrode and the sensor electrode is measured, in a similar fashion to the implementations discussed above.

The method 600 then moves to a block 615 where the mass of the object is estimated based on a measured capacitance between the sensor electrode and the EMS electrode, or a signal or value indicative of the same. As discussed above with respect to the determination of a pressure gradient or altitude, a measured capacitance or indicative value can be correlated with a corresponding object mass through the use of a lookup table or through direct calculation of the mass using a processor. Such a lookup table can be populated, for example, either through calculations based on the mechanical properties of the EMS device package, or through calibration using objects of known mass. In some implementations, the sensor can be calibrated or zero tared by measuring the capacitance or a signal or value indicative of the same prior to placing the object on the EMS device package.

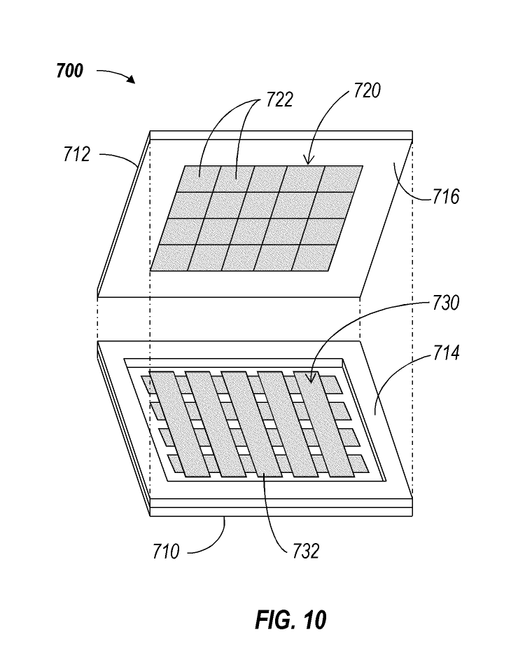

In some implementations, more than one sensor electrode may be provided on a backplate of an EMS device package, facilitating the making of more precise measurements. FIG. 10 shows an exploded view of another implementation of an EMS device package with more than one sensor electrode supported on an interior surface of a backplate. In illustrated implementation, the EMS device package 700 includes a sensor electrode array 720 including a plurality of sensor electrodes 722 disposed on the interior surface 716 of the backplate 712. In the illustrated implementation, the sensor electrodes 722 are arranged in a grid formation, although in other implementations other arrangements of sensor electrodes 722 may be used.

Like the row electrodes 732 in the underlying EMS array 730 on EMS device substrate 710, the sensor electrodes 722 in sensor electrode array 720 may be utilized either individually or in a gang-driven fashion. When used individually, or in small groups of electrodes, multiple capacitors may be formed by placing the sensor electrodes 722 (or groups thereof) in electrical communication with underlying electrodes within the EMS device array 720. By taking simultaneous or sequential measurements from multiple capacitors, additional information about the scope and shape of deformation can be provided.

For example, if an object to be weighed is placed on top of the assembled EMS device package 700, as described above with respect to method 600, a variance in capacitance between capacitors equidistant from but on opposite sides of the array may indicate that the object is not centered on the array, or imbalanced. When the sensor electrode array 720 is a grid as illustrated, the array 720 can be used provide feedback regarding the orientation of the object in more than one direction. This off-center loading can be taken into account when estimating the mass of the object, or feedback can be provided to a user to reposition the object as discussed above.

In other implementations, a sensor electrode array 720 such as the illustrated grid can be used to provide a touch sensor system, as the deformation profile of the substrate being deformed (either the backplate 712 or the EMS substrate 710) can be used to provide an indication of where a user is making contact with a surface being deformed under load. The resolution of such a touch system will be constrained in part by the size and number of the sensor electrodes 722 in the sensor electrode array 720, as well as the sampling speed of the capacitive sensing system. In some implementations, such a touch sensing system may not serve as a primary touch sensor in a device, but may instead provide supplemental touch functionality, such as the sensing of touch event on the back of a touchscreen device. In other implementations, such a sensing system can be used to provide touch functionality in a device without a dedicated touchscreen system.

In another implementation, the sensor electrode array 720 may include a central sensor electrode and one or more annular sensor electrodes disposed around the periphery of the central sensor. Such an arrangement, or any other multi-electrode arrangement, allows differential measurements to be made to provide further implementation about the amount and location of the relative displacement between the backplate 712 and the EMS substrate 710. Any other suitable number, shape and/or arrangement of sensor electrodes may also be used in other implementations.

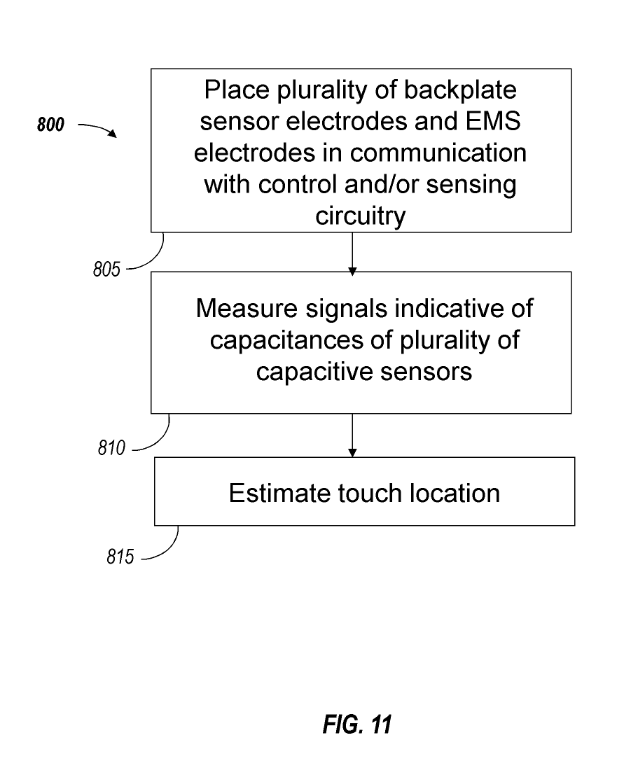

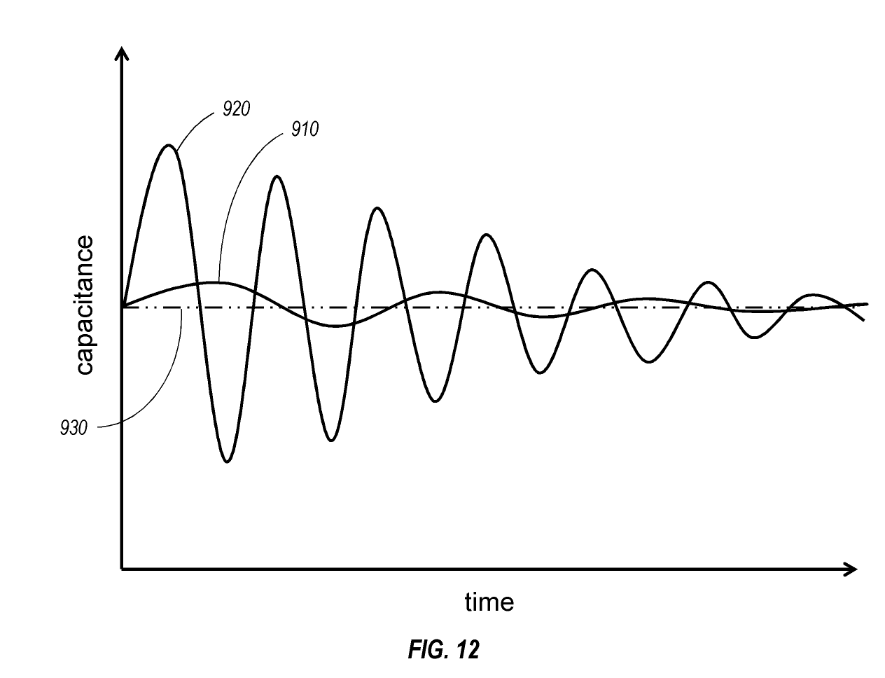

FIG. 11 shows an example of a flow diagram illustrating a method of sensing a touch event using an array of backplate sensors. The method 800 begins at a block 805, where an array of backplate sensor electrodes in an EMS device package such as those described with respect to FIG. 10 are placed in electrical communication with a plurality of electrodes within an EMS device array on the opposite substrate in the EMS device package. In some implementations, this coupling may be sequential, and each of the sensor electrodes may be placed in electrical communication with one or more electrodes in the EMS array in turn. In other implementations this coupling may be partially or simultaneous, with multiple capacitive sensors being simultaneously formed by these connections. For example, each of a sensor electrode in a column of sensor electrodes can simultaneously be placed in electrical communication with one or more underlying row electrodes, such as row electrodes extending substantially perpendicular to the column of sensor electrodes being addressed. In other implementations, each sensor electrode in the array may be simultaneously and discretely coupled to one or more underlying EMS electrodes, providing a capacitive sensor for each sensor electrode in the in the backplate sensor electrode array. In still other implementations, more than one sensor electrode may be gang driven together, to provide a capacitive sensor including multiple sensor electrodes. The gang driving of multiple sensor electrodes together may allow, for example, a higher sequential sampling rate at a lower resolution.

The method 800 then moves to a block 810, where a signal or value indicative of the capacitance of a plurality of capacitive sensors is measured. In some implementations, this may be done simultaneously for all capacitive sensors, as discussed above. In other implementations, capacitive sensors may be formed and tested in an iterative manner, with one or more capacitive sensors being formed by placing at least one sensor electrode in electrical communication with one or more EMS electrode, testing those capacitive sensors, disconnecting them, and forming a new set of connections to provide a different capacitive sensor or group of capacitive sensors which are tested in turn.

After each of a plurality of capacitive sensors at different positions throughout the EMS device package have been provided and tested, the method 800 moves to a block 815 where the capacitances of the of the plurality of capacitive sensors (or values or signals indicative of the same) are analyzed to determine the location, if any of a load causing deformation of the backplate relative to the EMS substrate, alternately referred to as a touch event. The relative difference in deformation, particularly a non-symmetric deformation, can be used to provide a rough indication of the location of the touch event. Analysis of a lack of symmetry is particularly helpful in determining a touch location, as the location of the touch may not necessarily correspond to the point of maximum deformation. In addition, as discussed above, because this method utilizes a measure of the relative deformation between the backplate and the EMS device substrate, a touch event on either surface of an EMS device package can be sensed.

Because an EMS device package can include two substrates sealed to one another with an air-filled cavity therebetween, the air (or other gas) in the cavity can serve as a coupling spring between the two substrates. Vibration of one of the substrates in the EMS device package will induce vibration of the other substrate due to the coupling between the two substrates. Over time, this vibration will decay due to damping within the system. The oscillation of the two substrates is dependent in part on the resonance frequency of the substrates, and the two substrates within an EMS device package may have different structural properties and different resonance frequencies.

Referring again to FIGS. 4A and 4B, in a device such as an IMOD display device configured to be viewed through the supporting EMS device substrate 110, the EMS substrate 110 may include more than one layer adhered or otherwise fixed relative to one another. For example, various implementations may include one or more of touchscreen systems, frontlight systems, optical layers, and protective cover glass. In some implementations, the overall combination of these layers, represented in FIG. 3A as an EMS substrate 110, may be stiffer than the backplate 112, which itself may include one or more layers fixed relative to one another. For convenience, these structures are referred to as substrates and backplates, although they may be multilayer structures in any of the implementations discussed herein. The resonance frequencies of these substrates may be calculated based on the known properties of these substrates. In one particular implementation, the resonance frequency of the backplate 112 may be roughly 3 kHz, while the resonance frequency of the stiffer EMS device substrate 110 may be roughly 4.8 kHz.

When one of the EMS substrate 110 and backplate 112 oscillate at a low frequency, the coupling between the two plates allows the other of the EMS substrate 110 and backplate 112 to oscillate generally in phase with the driving plate. If the capacitance between a sensor electrode 120 and an EMS electrode 132 (or a signal or value indicative of the same) is sequentially sampled, the change in capacitance over time will be minimal, and will be due in part to differences in the oscillation amplitude of the two plates as a result of different plate stiffness. However, at higher oscillation frequencies, the induced oscillation of the second plate may move out of phase with the driving oscillation of the first plate, significantly increasing the variation in capacitance as over time.

FIG. 12 shows a plot of induced changes in capacitance over time in response to both a stimulus that causes a low-frequency oscillation and a stimulus that causes a high-frequency oscillation. For example, movement of an EMS device package can induce a low frequency oscillation of one or both plates of the EMS device package. In particular, it can be seen that a stimulus that causes low-frequency oscillation results in a low-amplitude capacitance change 910 over time, as the two plates move generally in phase. An impact on the EMS device package, particularly on one of the plates of the package, will cause the impacted plate to oscillate at a higher frequency than the frequency induced by simple movement of the package, and the coupling between the two plates will induce high-frequency oscillation in both plates. In contrast to the low-amplitude capacitance change 910 induced by stimulus which causes the low-frequency oscillation, a stimulus which causes a high-frequency oscillation can result in a much higher amplitude of capacitance change 920 over time, due to the plates moving out of phase with one another and increasing the variance in the spacing between the places. Over time, the oscillation induced by an impact or other stimulus decays to the unloaded capacitance 930 of the system when the backplate and the EMS substrate are not deformed relative to one another.

As noted above, one source of high-frequency driving oscillations is an impact sustained by the EMS device package, such as when the package is dropped. If the capacitance is being sampled over time, the significant oscillation in capacitance that can be induced by such an impact can be analyzed to identify the occurrence of such an impact, as well as the information regarding time and the magnitude of the impact.

In a particular implementation, a measure of the capacitance as a measure of time can be analyzed in the frequency domain to identify signature frequencies indicative of an impact causing oscillation of the EMS substrate 110 and the backplate 112. For example, one or more band-pass filters tuned to signature frequencies can be integrated into the EMS device electronics, and tuned to signature frequencies of the EMS device package. These frequencies may be determined either through calculation based on the structural properties of the EMS device package components, or may be determined through testing of a device. Capacitive signals generated on these signature frequencies can be recorded and subsequently analyzed to determine a time and/or magnitude of impact.

An impact, such as the impact sustained from the EMS device package being dropped, will excite a substantial amount of resonance moves of the package in a wide range of frequencies, and these signature frequencies will only be excited by such an impact. Sufficiently fast sampling will provide a range of data points, and a the analysis of this data can include a Fourier transform translating the data from the time domain to the frequency domain. The range of frequencies which can be identified in the Fourier transform is dependent upon the sampling rate of the data in the time domain. In one implementation, the first mode in which the two plates of the EMS device package will resonate in an anti-phase manner relative to one another can be calculated or identified for a given EMS device package or package design. This frequency f1 of this first resonant mode can be a first signature frequency indicative of an impact on the EMS device package. So long as the sampling rate used is at least twice the first signature frequency f1, the presence of this resonance mode can be identified from the Fourier transform of the sampled data or through other suitable analysis of the measured data.

This sensing method allows the identification of an impact which causes damage to an EMS device and may, for example, indicate mishandling of the device and void a warranty. Such a sensing method would, in other devices, require the use of a discrete and less reliable accelerometer. For an IMOD-based display, a reliable shock sensor can be integrated into the display package without the need for substantial additional components, as the sensing circuitry can be integrated into the driver circuitry, and the sensor electrode structure can be a simple structure.

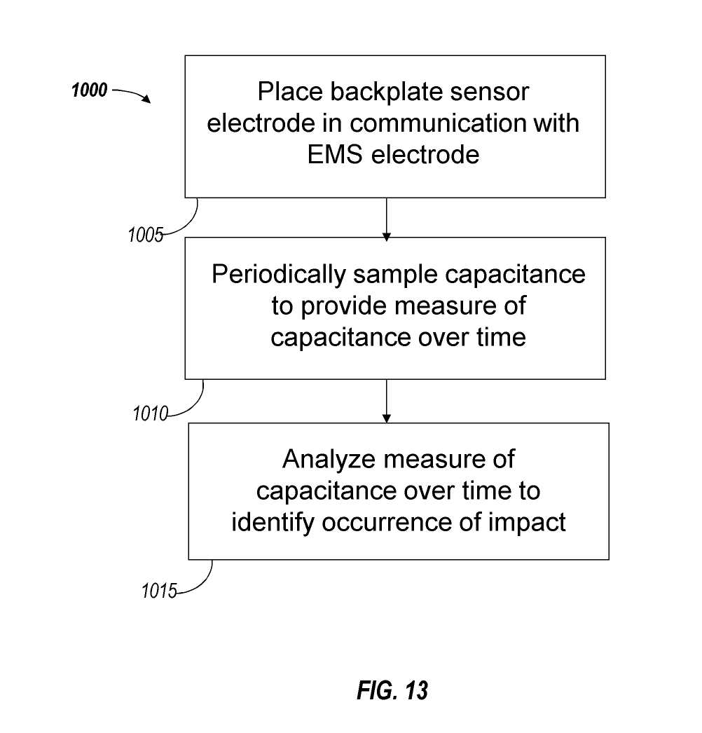

FIG. 13 shows an example of a flow diagram illustrating a method of detecting an impact on an EMS device package. The method 1000 begins at a block 1005, where a sensor electrode on a backplate of an EMS device package is placed in electrical communication with control and/or sensing circuitry, and an EMS electrode in an EMS device on a substrate sealed to the backplate to form the EMS device package. Is also placed in electrical communication with control and/or sensing circuitry.

The method 1000 then moves to a block 1010, where the capacitance between the sensor electrode and the EMS electrode is sampled periodically to provide a measure of the capacitance as a function of time. As discussed above, the actual capacitance at each point in time need not be determined, as a signal or value indicative of the capacitance can be analyzed instead of the actual capacitance values.

The method 1000 then moves to a block 1015, where the measure of the capacitance as a function of time is analyzed to identify the occurrence of an impact. In some implementations, this analysis can include a frequency analysis of the measure of the capacitance as a function of time, and in particular implementations, this may include passing the measured signal through one or more band pass filters tuned to signature frequencies of the EMS device package.

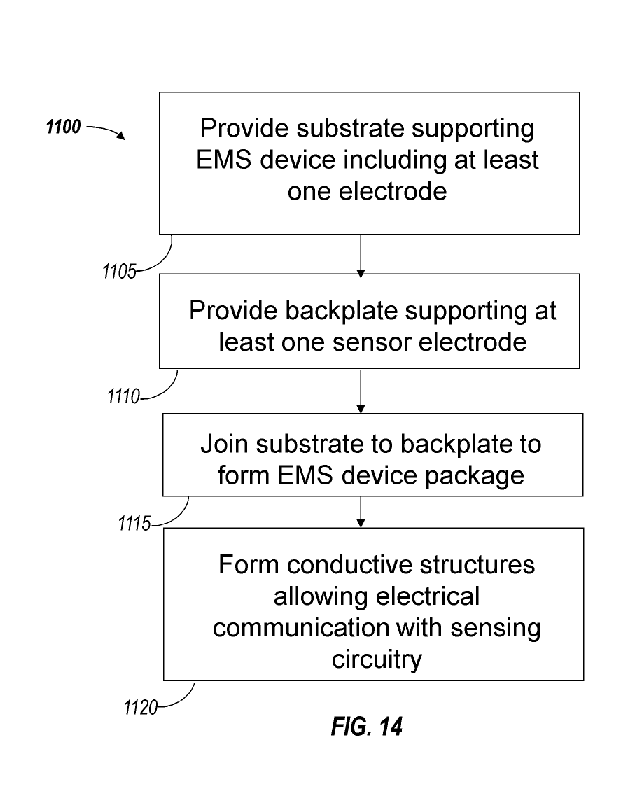

FIG. 14 shows an example of a flow diagram illustrating a method of fabricating an EMS device package having an integrated backplate sensor. The method 1100 begins at a block 1105 where a substrate supporting an EMS device is provided, the EMS device including at least one electrode. As discussed above, the substrate may support an array of EMS device such as IMODs or other suitable EMS devices, and the array may include many electrodes.

The method 1100 then moves to a block 1110, where a backplate is provided, the backplate supporting a sensor electrode. As discussed above, in some implementations the backplate may include an array of sensor electrodes, or a central sensor electrode and one or more annular sensor electrodes disposed around the periphery of the central sensor electrode.

The method 1100 then moves to a block 1115, where the backplate and the substrate are joined together to form an EMS package. This joining process may include, for example, the use of a seal, frit, or other intervening component or material to join the backplate to the substrate, although in other implementations the backplate can be directly joined to the substrate without the use of an intervening material.

The method 1100 then moves to a block 1120 where connective structures are formed which allow electrical communication between the sensor electrode and control and/or sensing circuitry, as well as between the electrode of the EMS device and control and/or sensing circuitry. In an implementation in which the EMS device package includes driver circuitry configured to control the EMS device, these connective structures may include the connective structures which place the driver circuitry in electrical communication with the EMS device. These connective structures need not provide constant electrical communication between the sensing circuitry and the sensor electrode or the electrode of the EMS device, but can include switches or other structures which allow selective coupling between the sensing circuitry and the sensor electrode or the electrode of the EMS device.

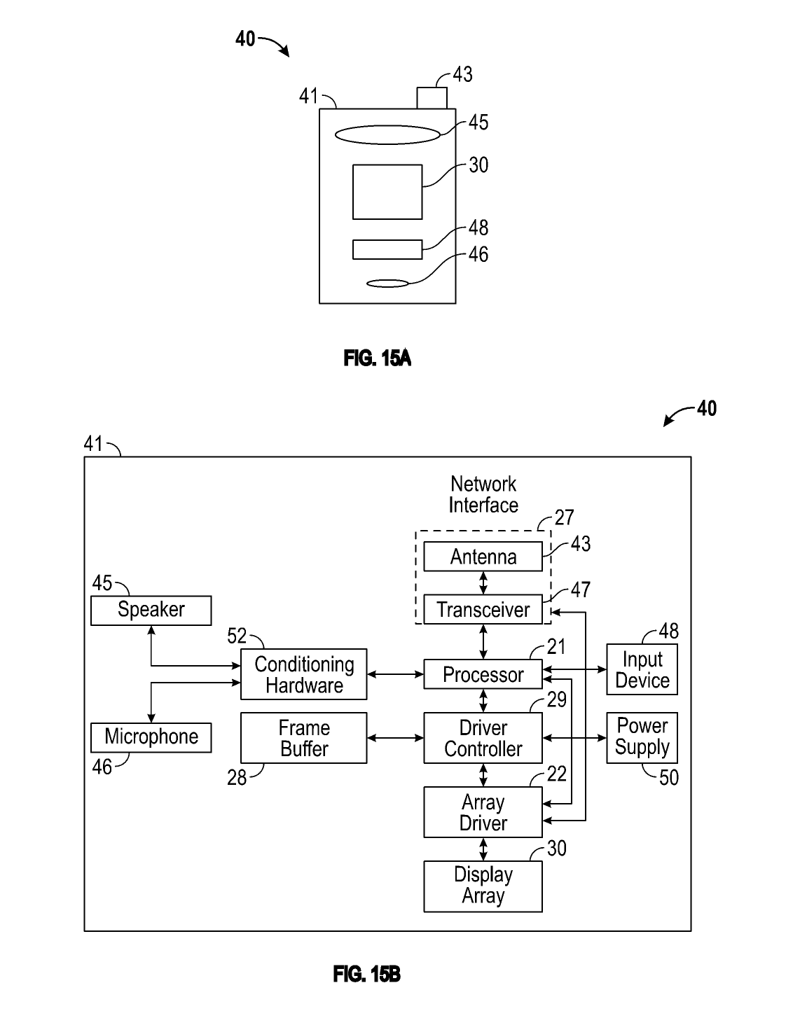

In some implementations, the sensing circuitry may be disposed on one of the backplate or the substrate. If the sensing circuitry is disposed on the backplate, the connective structures between the sensing circuitry and the sensor electrode may be formed prior to joining the backplate to the substrate, and the connective structures between the sensing circuitry and the electrode of the EMS device may be formed at least partially during the joining process, such as by the use of flex tape, anisotropic conducting film, bump-to-bump connections, or any other suitable process. Similarly, if the sensing circuitry is disposed on the EMS device substrate, the connective structures between the sensing circuitry and the electrode of the EMS device may be formed prior to joining the backplate to the substrate, and the connective structures between the sensing circuitry and sensor electrode may be formed at least partially during the joining process. [0099] FIGS. 15A and 15B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 15A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 15A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical systems (EMS) device package, comprising:
a substrate having a first surface,
at least one EMS device supported by the first surface of the substrate, the at least one EMS device including an electrode configured to be placed in electrical communication with sensing circuitry;
a backplate sealed to the first substrate to form a cavity enclosing the at least one EMS device; and
at least one sensor electrode supported by the backplate and configured to be placed in electrical communication with the sensing circuitry to form a capacitive sensor between the sensor electrode and the electrode of the at least one EMS device.

2. The package of claim 1, wherein the package includes:
a plurality of sensor electrodes supported by the backplate; and
a plurality of EMS devices supported by the first surface of the backplate, wherein the plurality of sensor electrodes are configured to be placed in communication with electrodes in the plurality of EMS devices to form a plurality of capacitive sensors.

3. The package of claim 2, wherein the plurality of sensor electrodes include an array of sensor electrodes arranged in a grid.

4. The package of claim 2, wherein the plurality of sensor electrodes include the at least one sensor electrode and a second electrode disposed along a periphery of the at least one sensor electrode.

5. The package of claim 4, wherein the second electrode is a substantially annular electrode circumscribing the at least one sensor electrode.

6. The package of claim 1, wherein the sensing circuitry is configured to measure a signal indicative of the capacitance between the at least one sensor electrode and the electrode of the at least one EMS device.

7. The package of claim 6, wherein the sensing circuitry is additionally configured to estimate the weight of an object supported by the EMS device package based at least in part on a measure of the capacitance between the at least one sensor electrode and the electrode of the at least one EMS device.

8. The package of claim 6, wherein the sensing circuitry is additionally configured to determine a pressure difference between a pressure within the package and an ambient pressure outside the package.

9. The package of claim 8, additionally including a temperature sensor.

10. The package of claim 8, wherein the sensing circuitry is additionally configured to estimate an altitude of the package.

11. The package of claim 6, wherein the at least one sensor electrode includes a plurality of sensor electrodes, and wherein the sensing circuitry is additionally configured to estimate a location of a touch event relative to the package.

12. The package of claim 6, additionally including at least one band-pass filter in electrical communication with the sensing circuitry.

13. The package of claim 12, wherein the at least one band-pass filter is tuned to a frequency indicative of an impact on the package, wherein the sensing circuitry is additionally configured to determine whether the package has sustained an impact based at least in part on a measure of the capacitance between the at least one sensor electrode and the electrode of the at least one as a function of time.

14. The package of claim 1, wherein the at least one sensor electrode is disposed on a surface of the backplate facing the substrate.

15. The package of claim 1, wherein the at least one sensor electrode is disposed on a surface of the backplate opposite the substrate.

16. The package of claim 1, wherein the EMS device forms a portion of a display, the package further comprising:
a processor that is configured to communicate with the display, the processor being configured to process image data; and
a memory device that is configured to communicate with the processor.

17. The package of claim 16, further comprising:
a driver circuit configured to send at least one signal to the display; and
a controller configured to send at least a portion of the image data to the driver circuit.

18. The package of claim 17, wherein the driver circuit includes the sensing circuitry.

19. The package of claim 16, further comprising an image source module configured to send the image data to the processor, wherein the image source module comprises at least one of a receiver, transceiver, and transmitter.

20. The package of claim 16, further comprising an input device configured to receive input data and to communicate the input data to the processor.

21. An electromechanical systems (EMS) device package, comprising:
a substrate having a first surface,
at least one EMS device supported by the first surface of the substrate, the at least one EMS device including an electrode;
a backplate sealed to the first substrate to form a cavity enclosing the at least one EMS device; and
means for sensing a relative displacement between the substrate and the backplate, wherein the sensing means are supported by the backplate.

22. The package of claim 21, wherein the sensing means comprises at least one sensor electrode supported by the backplate and configured to be placed in electrical communication with sensing circuitry to form a capacitive sensor between the sensor electrode and the electrode of the at least one EMS device.

23. A method of fabricating an electromechanical systems device (EMS) package, the method comprising:
providing a substrate supporting an EMS device, wherein the EMS device includes at least one electrode;
providing a backplate supporting at least one sensor electrode;
joining the substrate to the backplate to form an EMS device package including the EMS device; and
forming conductive structures allowing electrical communication between sensing circuitry and the at least one sensor electrode, and between the sensing circuitry and the at least one electrode of the EMS device.

24. The method of claim 23, wherein the backplate additionally supports sensing circuitry connected to the at least one sensor electrode.

25. The method of claim 23, wherein the substrate additionally supports sensing circuitry connected to the at least one electrode of the EMS device.

26. The method of claim 23, wherein the at least one sensor electrode includes an array of sensor electrodes.

27. The method of claim 23, wherein the at least one sensor electrode includes a central sensor electrode and at least one annular sensor electrode extending around the periphery of the central sensor electrode.

28. The method of claim 23, wherein the sensing circuitry forms at least a portion of a driver circuit configured to control the EMS device.
